(19) United States
(12) Patent Application Publication
(10) Pub. No.: US 2002/0155878 A1
(43) Pub. Date: Oct. 24, 2002

(54) Advertising games and method

(75) Inventors: John G. Lert JR., Westport, CT (US); Jacob Mark, Needham, MA (US)

Correspondence Address: FRISHAUF, HOLTZ, GOODMAN, LANGER & CHICK, P.C., ATTORNEYS AT LAW, 767 THIRD AVENUE, NEW YORK, NY, 10017-2023, US

(73) Assignee: UNIPOWER SOLUTIONS USA, INC., Quincy, MA (US)

(21) Appl. No.: 10/002,471

(22) Filed: Oct. 26, 2001

Related U.S. Application Data
(60) Provisional application No. 60/254,984, filed on Dec. 12, 2000.

(51) Int. Cl. A63F 13/00

(52) U.S. Cl. 463/19

(57) ABSTRACT

A system and method for engaging consumers in interactive, screen-based games that include brand images as an intrinsic element of the games. More specifically, the games preferably involve matching similar images, such that players of a game are required to focus their attention and concentration on brand images as part of the game process in order to succeed in the game's goal. Thus, the act of playing the game itself produces high-quality brand impressions, which then produce brand awareness and recognition. These games are completely electronic, being played using some form of a computer screen to display a game board. They can be played at home or at an office using a personal computer, in a store using an on-cart touch-screen display, or while traveling using a PDA or “pocket PC”.

### CROSS REFERENCE TO RELATED APPLICATION

The present application claims the benefit under 35 USC 119(e) of U.S. application Ser. No. 60/254,984 filed Dec. 12, 2000, the entire disclosure of which is incorporated herein by reference.

### BACKGROUND OF THE INVENTION

1. Field of the Invention

The present invention relates to methods of advertising and promoting consumer products, and more specifically to games for advertising and promoting brand images.

2. Background Information

Advertising has long been an essential method for marketing consumer packaged goods to mass markets, and much of the effectiveness of advertising comes from its ability to generate brand awareness and brand recognition. With the advent of television, and its ability to present electronic images of products to mass audiences, advertising has reached new levels of effectiveness and efficiency.

However, in recent years the continued evolution and proliferation of media technologies have significantly complicated the advertising process for manufacturers of consumer products. For example, the growth of cable television and direct-satellite television, both of which offer consumers many more programs from which to choose, has resulted in a major “fragmentation” of television audiences, making it much more difficult to reach mass audiences with television advertising. Even more recently, the phenomenal growth in the use of personal computers (PC) on the Internet has actually reduced the amount of time people spend watching television.

Of course, the Internet is itself an advertising medium with great potential, but the interactive nature of the Internet experience is very different from the purely passive nature of television viewing. To maximize the effectiveness of advertising in this medium, advertisers must develop completely new methods of advertising that exploit the interactive capabilities of the PC and the Internet. Interestingly, interactive games are widely used on the Internet for their entertainment value as a means of attracting people to web sites so they can be exposed to advertising messages. However, none of the known interactive games use brand images, as a fundamental element of the game itself, to encourage brand recognition of products.

One result of the fragmentation of television audiences has been the proliferation of alternative media, some rather unconventional, for the placement of advertising. Examples include televisions in airport passenger-waiting areas; interior and/or exterior billboards on buses, trains, and even private automobiles; screens on self-service pumps at gas stations, and reportedly even in bathroom stalls. Of course, for manufacturers of consumer products, the very best location for advertising is in the stores where their products are sold, and many new forms of in-store advertising have appeared in recent years. These include television/VCR units and electronic signs in the aisles, screens in checkout lanes, and even screens on carts.

Of course, a side effect of the proliferation of such ubiquitous advertising is an extreme “cluttering” of the media environment. Consumers continuously bombarded by advertising messages have developed very effective cognitive methods of filtering out much of the advertising “noise” as a defensive mechanism, with the result that it is becoming increasingly difficult for advertisers to get their messages noticed by their intended audience.

### OBJECTS AND SUMMARY OF THE INVENTION

It is therefore an object of the present invention to provide a method of advertising that employs an interactive game that uses brand images to generate brand awareness and recognition among consumers.

It is a further object of the present invention to provide a method of advertising and promotion in the form of an interactive game that consumers will elect to play because of its intrinsic entertainment value, as well as the opportunity to win prizes.

It is a further object of the present invention to generate effective brand impressions by causing players of an interactive game to focus attention and concentration on brand images in the playing of the game.

It is a further object of the present invention to generate effective brand impressions by causing players of an interactive game to compare a plurality of brand images for the purpose of identifying matches between identical images.

It is a further object of the present invention to generate brand awareness and recognition to shoppers in a store.

It is yet a further object of the present invention to provide an advertising and promotion method which overcomes inherent problems of known advertising and promotion methods.

In accordance with one form of the present invention, a method of playing a product brand image game using a game board which has a grid pattern having a plurality of boxes includes providing a game board to a user. The game board has associated with each of the plurality of boxes at least one of a product image or a “free” space. The method also includes randomly selecting a plurality of product images from a database of product images, and determining which of the plurality of randomly selected product images match the product images present on the game board.

In accordance with another form of the present invention, a game board includes a plurality of boxes each having associated therewith a row and a column. Each of the plurality of boxes has associated therewith a product image or a “free” space. Each of at least one of the row and column has associated therewith indicia which is deemed to be common to all of the corresponding row or column.

In accordance with another form of the present invention, a method of encouraging brand image awareness includes the steps of configuring a game board for one of bingo, memory or Keno using brand images, and having a user use the game board to play the corresponding game.

In accordance with another form of the present invention, a method of playing a product brand image game includes the steps of providing a plurality of boxes having a common picture which is visible to a user. Each of the plurality of boxes has associated therewith one of a plurality of brand images. Each of the plurality of brand images has at least one matching brand image associated therewith corresponding to a different one of the plurality of boxes. Each of the plurality of brand images is non-visible to a user until the corresponding one of the plurality of boxes is selected by the user. The method also includes having a user select two of the plurality of boxes and revealing the brand images corresponding to the selected boxes to determine if the selected boxes have matching brand images. If the brand images associated with the selected boxes match, the user is given credit for a match. If the brand images associated with the selected boxes do not match, the corresponding non-matching brand images are temporarily revealed to the user and then the non-matching brand images are replaced by the common picture so that the brand images are again non-visible to the user.

A preferred form of the present invention as well as other embodiments, objects, features and advantages will be readily apparent from the following detailed description of illustrative embodiments, which is to be read in connection with the accompanying drawings.

### BRIEF DESCRIPTION OF THE DRAWINGS

FIG. 1 is a block schematic diagram of control electronics for implementing a game for advertising and promoting brand images according to the present invention;

FIG. 2 is a perspective view of a display panel attached to a shopping cart as used by a shopper in a supermarket in the preferred in-store embodiment of the invention;

FIG. 3 is one embodiment of a Bingo game board of the present invention;

FIG. 4A shows four randomly selected “draws” for use in connection with the game board of FIG. 3;

FIG. 4B is the game board of FIG. 3 after the four randomly selected “draws” of FIG. 4A are applied thereto;

FIG. 5A shows two additional randomly selected “draws” for use in connection with the game board of FIG. 4B;

FIG. 5B is the game board of FIG. 4B after the two additional randomly selected “draws” of FIG. 5A are applied thereto;

FIG. 6 is a flow chart of the method of advertising and promoting brand image awareness according to the present invention; and

FIG. 7 is an alternative embodiment of the game board of the present invention.

FIG. 8A is yet another alternative embodiment of a game board of the present invention, in this case for Memory, with the images facing up to show their locations;

FIG. 8B is the game board shown in FIG. 8A as the players would see it at the start of the game with the brand images being non-visible;

FIG. 9A shows a pair of images revealed on a first turn using the game board shown in FIG. 8A;

FIG. 9B shows a third image revealed on the first selection of the second turn using the game board shown in FIG. 8A; and

FIG. 9C shows a pair of matching images revealed upon the second selection of the second turn shown in FIG. 9B.

### DETAILED DESCRIPTION OF THE PREFERRED EMBODIMENT

The present invention engages consumers in interactive, screen-based games that include brand images as an intrinsic element of the game itself. More specifically, these games preferably involve matching similar images, such that players of a game are required to focus their attention and concentration on brand images as part of the game process in order to succeed in the game's goal. Thus, the act of playing the game itself produces high-quality brand impressions, which then produce brand awareness and recognition. These games are completely electronic, being played using some form of a computer screen to display a game board. They can be played at home or at the office using a PC, in a store using a touch-screen display attached to a shopping cart, or while traveling using a PDA (personal digital assistant) or “pocket PC”.

Two preferred games are discussed in detail below, Bingo and Memory, but many other games can be adapted using the same basic principle.

In brand-image Bingo, brand images take the place of numbers. The game board preferably includes an array of 25 cells, configured as five rows by five columns, with each of the columns headed by one of the letters “B”, “I”, “N”, “G”, “O” in sequence form left to right. Whereas each cell of a standard Bingo card contains a number (except for the center cell, which is usually a “free” cell), in accordance with the present invention each such cell contains a brand image. Similarly, while each “draw” in a standard Bingo game produces a combination of a letter and a number, a draw in accordance with the present invention produces a combination of a letter and a brand image. As with standard Bingo, a “hit” occurs on a game board when a cell in the column specified by the letter of the draw contains the same brand image of the draw. A player wins the game when a pattern of hits occurs on the game card, e.g., five sequentially contiguous cells (horizontally, vertically, or diagonally), four corners, a “T” pattern (top row and center column), an “H” pattern (right and left columns and middle row), all cells, or any other pattern.

Brand impressions result from the player viewing the brand image of each “draw”, as well as viewing the brand images on the game board to determine if there is a match of each drawn image and to determine if the winning pattern of matches exists on the board. It should be noted that, as the player gets close to winning, the player will likely become more excited, and brand impressions will therefore become more intense in the player's mind and potentially effective, both in general and especially for certain specific brand images. For example, if a game board is missing only one cell of the winning pattern, the player will naturally focus attention on the brand image in that cell, looking for a matching image in each draw. Naturally, this increased focus will have the effect of improving the player's attention and awareness of that brand in the future.

Like standard Bingo, brand-image Bingo can be played in competition with other players, such that the first player in a competing group to get a winning pattern of hits on a game card wins the game. Alternatively, the game can be structured to be played solo; for example, each player or game card might be allowed a fixed number of draws or a certain time limit within which to get the winning pattern.

Bingo is the ideal game to be used in an in-store embodiment both because of its inherent familiarity to customers, and because playing it does not require a great deal of time or effort on the part of shoppers who are typically in a hurry to complete their shopping. Conversely, for the intended advertising purposes of the game, the store is absolutely the best venue in which the game can be played, because the advertising impressions are created during the course of a shopping trip during which a purchase can occur.

In Memory (also known as Concentration), matching pairs of cards are placed face down in a rectangular array. Standard playing cards can be used, and there are also numerous Internet and packaged versions of the game that use matching images of objects (such as baby animals, automobiles, etc.). In brand-image Memory, brand images of consumer products are used. Players take turns revealing cards, two per turn, the object being to reveal matching pairs. If the two cards do not match, they are turned back over face down, eligible to be used in future turns. If the two cards do match, they are removed from the game and the player immediately gets another turn. The game ends when all matching pairs have been found.

Memory players can compete together, using the same board, the winner being the player who finds the greatest number of matching pairs. Alternatively, the game can be structured to be played solo, with a specified limit on time or number of turns, or using a scoring system based on the number of matches relative to time or number of moves. Finally, the game can be played against a computer.

The game takes its name (either Memory or Concentration) from the fact that the player must remember the locations of specific cards that have been revealed on previous turns and therefore must concentrate on associating the revealed images with the locations of the cards on each turn so that the sight of the same image on a different card will trigger a memory of the location of the matching card. Due to this requirement of focused concentration, Memory is typically unsuitable for play in an in-store embodiment of the invention. However, for the same reason, Memory is ideal for an at-home embodiment, since the visual memory of brand images created in the game will trigger strong brand recognition in the store, thereby increasing the likelihood of purchase.

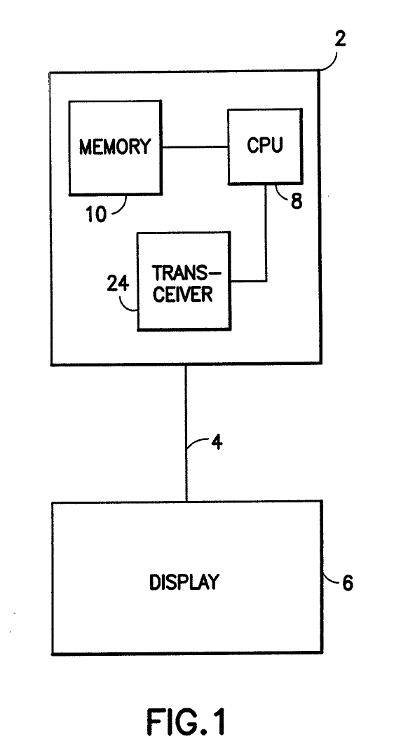

Referring now to FIG. 1, the system architecture of the preferred embodiment of the invention, applicable both to in-store and at-home embodiments, is shown. A server apparatus 2 that controls operation of each game is connected via a network connection 4 to a plurality of display devices 6 with which players interact. In an in-store embodiment, the server apparatus 2 is preferably located in the store, the network connection 4 is a wireless local-area network, and the display devices 6 are preferably tablet computers mounted on shopping carts. In an at-home embodiment of the invention, the server apparatus 2 is a web server, the network connection 4 is preferably the Internet, and the display devices 6 are preferably home computers.

The server apparatus 2 includes CPU 8, to which is coupled a memory (database) 10. The memory 10 stores a plurality of brand images and other graphical elements which are used by the CPU 8 to create “pages” of information in Hypertext Markup Language (HTML), which are interpreted and displayed by browser software running on the display device 6. Further details about the operation of the system shown in FIG. 1 will become evident below in the description of two games, Bingo and Memory.

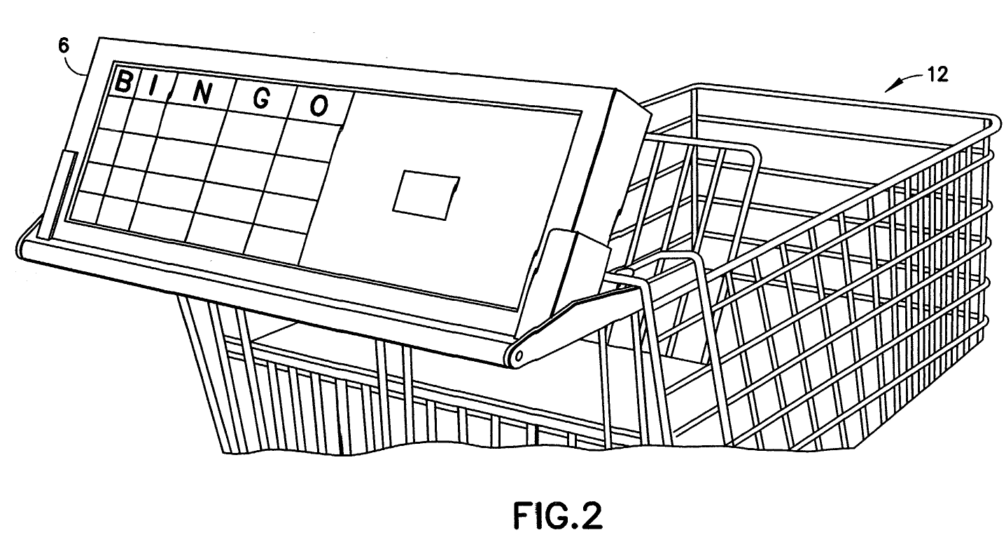

Referring now to FIG. 2, a preferred embodiment of the display 6 for use in connection with an in-store embodiment of the present invention is shown mounted to a shopping cart 12. The display is preferably attached to the handle of the shopping cart so as to be easily viewed by a shopper while shopping. The display preferably includes a transparent touch-sensitive overlay that is responsive to touches by the user. Suitable displays for use in connection with the present invention are shown in U.S. Pat. No. 4,973,952; U.S. Pat. No. 5,295,064; and U.S. Pat. No. 5,287,266, the entire disclosures of which are incorporated herein by reference.

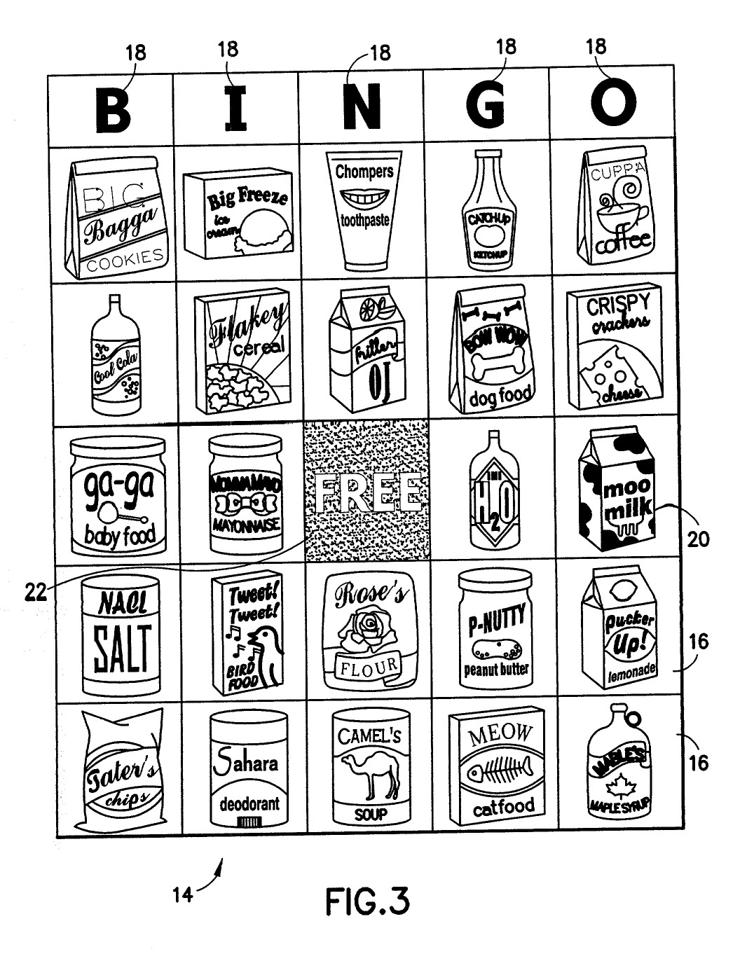

Bingo is the preferred game for the in-store embodiment of the present invention. Referring now to FIG. 3, a preferred form of the initial Bingo game board 14 is shown. The game board is similar to a conventional Bingo card in that is consists of a two-dimensional array of cells 16 arranged in rows and columns, preferably five rows and five columns with a letter 18 at the top of each column corresponding to one of the letters of the word “BINGO”. However, whereas each cell in a conventional Bingo game contains a number in each cell, in the present invention each cell includes a brand image 20. During the course of the game, a series of “draws” occur, each of which might match the contents of a cell on a game board, and the object of the game is to find cells on the board whose content matches “draws” in a specified pattern. In the preferred embodiment, as with conventional Bingo, the center cell 22 of the game board 14 is designated a cell which counts as an automatic match and can be included in a Bingo pattern without any matching draw.

Complete game boards can be stored in the memory 10 and randomly selected by the CPU. Alternatively, each game board can be newly generated for each game and player by selecting product images and randomly placing the selected images in the cells 16. In one embodiment, a database of the purchase history of each player is also stored in memory 10, and brand images 20 for each game board 14 are selected as much as possible from the product categories purchased by the player. The game board 14 is generated (or selected) by the CPU 8 (via access to memory 10) and transmitted via a transceiver 24, preferably as an HTML page, to display device 6 for viewing.

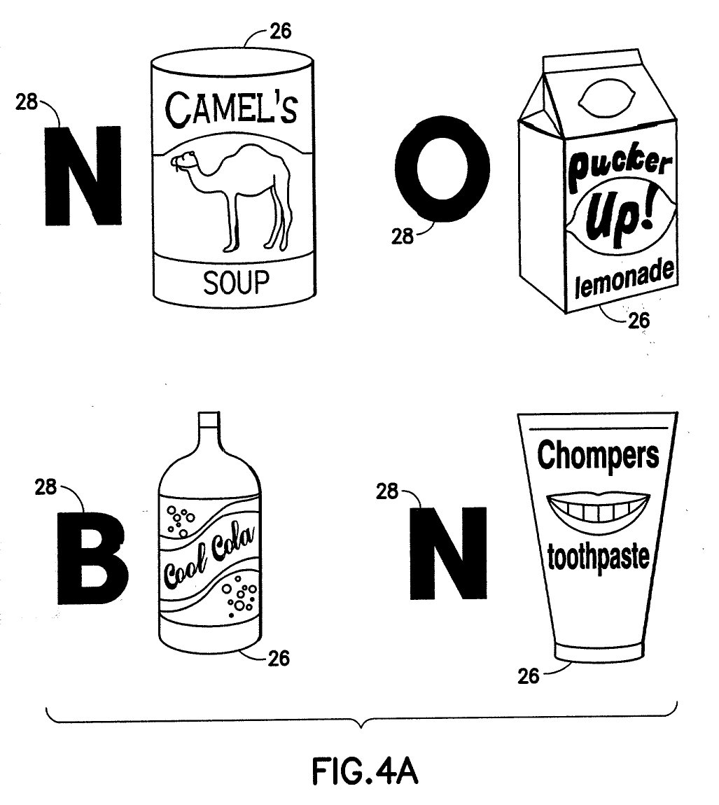

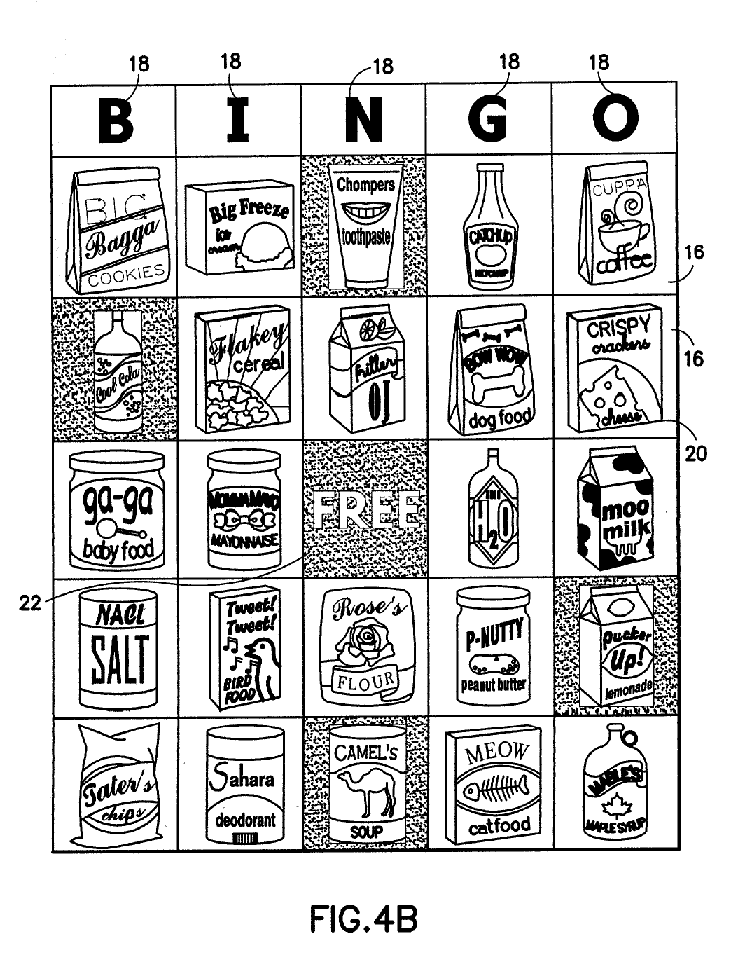

Periodically as a shopper traverses the aisles of the supermarket, the server's CPU 8 generates “draws” and transmits each draw, preferably within an HTML page, via transceiver 24 for viewing on display 6 of the shopping cart 12. Referring now to FIG. 4A, four such draws are shown. The CPU generates each draw by selecting a brand image 26 and letter 28 from memory 10. The selected letter corresponds to one of the letters identified at the top of the columns of the game board 14. Upon each draw, the computer-selected brand image of the draw is compared with the product images shown on the shopper's game board in the column headed by the computer-selected letter of the draw. If a match is found, the matching cell on the game board will change in appearance to provide an indication of a match, for example by flashing on and off or by a change in the color of its border.

FIG. 4B shows the result of the four draws shown in FIG. 4A on the game board 14 shown in FIG. 3.

In a standard Bingo game, multiple players compete together with each other, each player having at least one (and usually more) game card, with draws applying to all game cards, and the game ends when any of the players gets a Bingo (e.g. a completed row or column) on a game card. While this method would obviously be possible in an at-home embodiment of this invention, in the preferred in-store embodiment, however, it is advantageous to play each game solo. In this approach, each shopper can begin a fresh game at the start of a shopping trip rather than enter a game already under way, and more importantly, the computer-generated draws can be customized to each player. Just as the set of brand images placed on a game board is preferably based on the types of products that the player purchases, the images drawn by the computer during the course of the game should preferably be selected on the same basis. In a further refinement of the preferred embodiment, the location of each player in the store would be known, and priority would be given to images of products that are closest in proximity to the shopper. In this way the chance of stimulating an impulse purchase from a brand impression would be highest. For example, if a shopper's history stored in the memory indicates that the shopper buys crackers and the shopper is in or near the cracker aisle at the time of a given draw, the computer would be more likely to select a brand image of a cracker product on that draw than, say, a toothpaste product located elsewhere in the store.

Brand impressions are created when the player views the brand images either in the draws or on the game board, and the most effective impressions occur when the player seeks to match drawn images. To maximize the advertising benefit, then the ideal method of playing the game is to use the standard Bingo rule that requires the player to find each match on the game board, as this process would involve repeated scanning the board, i.e., the column specified on each draw. When a player finds a match, he or she would confirm it, for example by touching the screen or by clicking a mouse. However, while this method of play would be quite acceptable in an at-home version of the game, the preferred in-store embodiment sacrifices some advertising effectiveness in order to make playing the game faster, more convenient, and consequently less bothersome while shopping, otherwise shoppers will be less likely to play the game altogether. In the store, the player must touch the brand image of each draw in order to make a match possible. This ensures at least a minimal level of brand impression and possible advertising exposure, but preferably the CPU 8 automatically finds and identifies all matches for the customer.

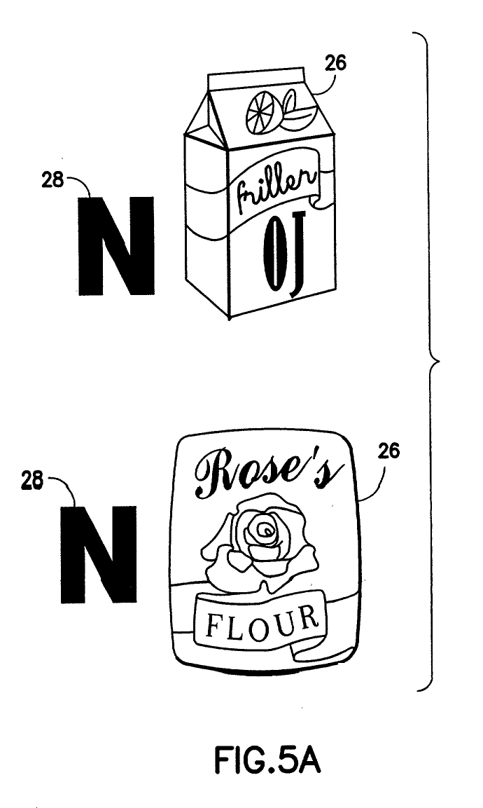

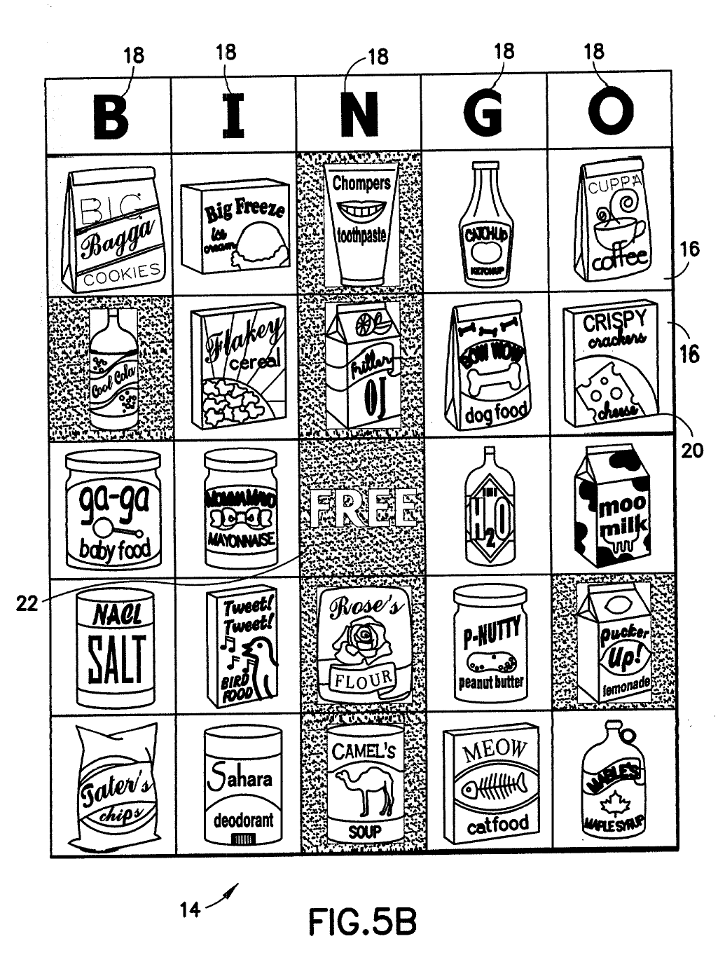

Referring now to FIG. 5A, two additional product images 26 and letters 28 selected by the CPU 2 are shown. The game board 14 that results after the display of these two product images and letters is shown in FIG. 5B. As is evident from FIG. 5B, the shopper has won the game by filling in a complete column (i.e., the column designated by the letter “N”) of the game board. The store can then provide the winner with a prize for winning, such as cash, credit when they checkout, or a free product (e.g., from one of the cells in the matching pattern), or any other prize.

Various patterns of matches can be allowed to constitute a win. Some examples include matching a complete column (as shown in FIG. 5B), a complete row, a diagonal between opposite corners, or the four corners, or any other designated pattern.

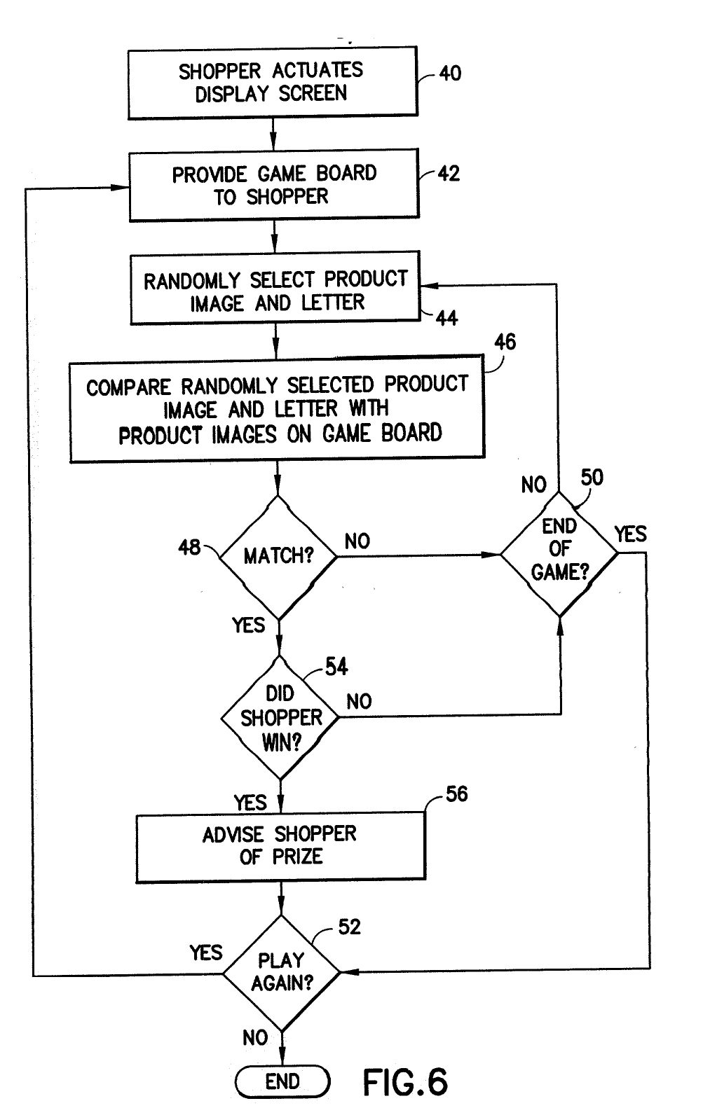

Referring now to FIG. 6, a flow chart of the method of advertising and promoting brand images is shown. Initially, as the shopper obtains a shopping cart and enters the store, the shopper actuates the display screen of the shopping cart to indicate a desire to play the brand image game (Step 40). The request is received electronically (e.g., preferably via an RF transmission) by the CPU 8 which then generates a game board that is transmitted to and displayed on the shopping cart display 6 (Step 42). Thereafter, at periodic intervals (in the preferred embodiment every 5 minutes or less), the CPU selects (“draws”) a product image and an associated letter from the memory 10 and transmits them to the display 6 (Step 44). The shopper then compares the randomly selected product image 26 and letter 28 which appear on the display to the product images 20 and letters 18 shown on the game board 14 (Step 46).

A determination is then made as to whether there is a match between the product image 26 and letter 28 transmitted by the CPU and the product images 20 and letters 18 present on the game board 14 (Step 48). If a match is not observed (NO in Step 48), then a determination is made as to whether the end of the game has been reached (Step 50). In the preferred embodiment, the game ends after a specific number of draws (in the preferred embodiment, 10 draws), after which, if the shopper has not won, a new game is started. If the end of the game has not been reached (NO in Step 50), then another randomly selected product image and letter (“draw”) is generated (Step 44). However, if the end of the game is reached (YES in Step 50), then the shopper is asked if another play of the game is desired (Step 52). If the shopper would like to play again (YES in Step 52), then the method returns to Step 42 where a new game board is generated and provided to the shopper. If the shopper does not desire to play again (NO in Step 52), then the method ends.

Returning now to Step 48, if there is a match between the randomly selected product image 26 and letter 28 and the images 20 and letters 18 shown on the game board 14 (YES in Step 48), a determination is made as to whether the shopper has a winning game board (Step 54). If the shopper does not have a winning game board (NO in Step 54), then a determination is made as to whether the end of the game has been reached (Step 50). If the end of the game is not reached (NO in Step 50), the method returns to Step 44 as explained above. If the shopper did win (YES in Step 54), then the shopper is advised of his prize (Step 56) and the user is asked if he would like to play again (Step 52) as explained above.

While Bingo is the game of choice for play during a shopping trip in a store, Memory is an ideal game for play outside the store, e.g., at home or office, because it requires the player not just to match images but to create a visual memory and recognition of brand images as a fundamental part of playing the game. This game can be played with multiple players taking turns, or with a single player. The single-player version will be described in detail first, and the key differences of multi-player embodiments will then be discussed.

Referring now to FIG. 8A, an exemplar game board 60 for Memory is shown, as generated initially by the server apparatus 2, with brand images 62. The game board consists of a rectangular array of cells arranged in rows and columns, with each cell containing a brand image 62. The specific number and arrangement of such cells is fairly arbitrary and can be varied based on the preferences of the player(s) and also on the number of different players competing in a game. The greater the number of players, the greater the number of cells. For simplicity, FIG. 8A contains only three image pairs arranged in an array of three columns by two rows.

The CPU 8 preferably generates a game board by selecting from its memory (database) 10 a number of images equal to one-half of the desired number of cells on the game board, duplicating each image to create matching pairs, and arranging these images randomly into an array of columns and rows. FIG. 8B shows the initial view of the same game board shown in FIG. 8A as the player would see it at the start of a game, with the brand images being non-visible with a single graphical image 64 shown on each cell. It is anticipated that these games will typically be offered for play on web sites operated by retailers, in which case a logical common graphical image 64 would be the participating retailer's logo, as shown in FIG. 8B.

As with Bingo, complete game boards 60 can be stored in the memory 10 and randomly selected by the CPU 8, or alternatively, each game board can be newly generated for each game by selecting product images from memory 10 and randomly placing the selected images in the cells. Further, in the preferred embodiment, a database of the purchase history of the player is stored in memory 10, and brand images are preferably selected from the product categories of items purchased by the player. Once generated (or selected) by the CPU 8, the initial game board 60 is transmitted via transceiver 24, preferably as an HTML page, to the display device 6 for viewing. The player selects a cell to be revealed by clicking the mouse on the cell, and a turn consists of two such selections.

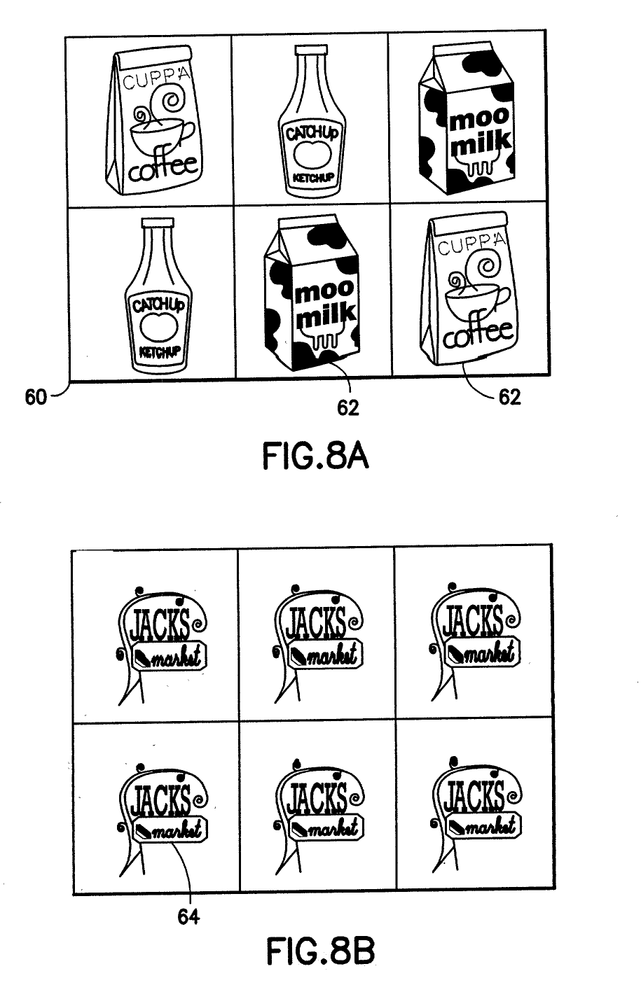

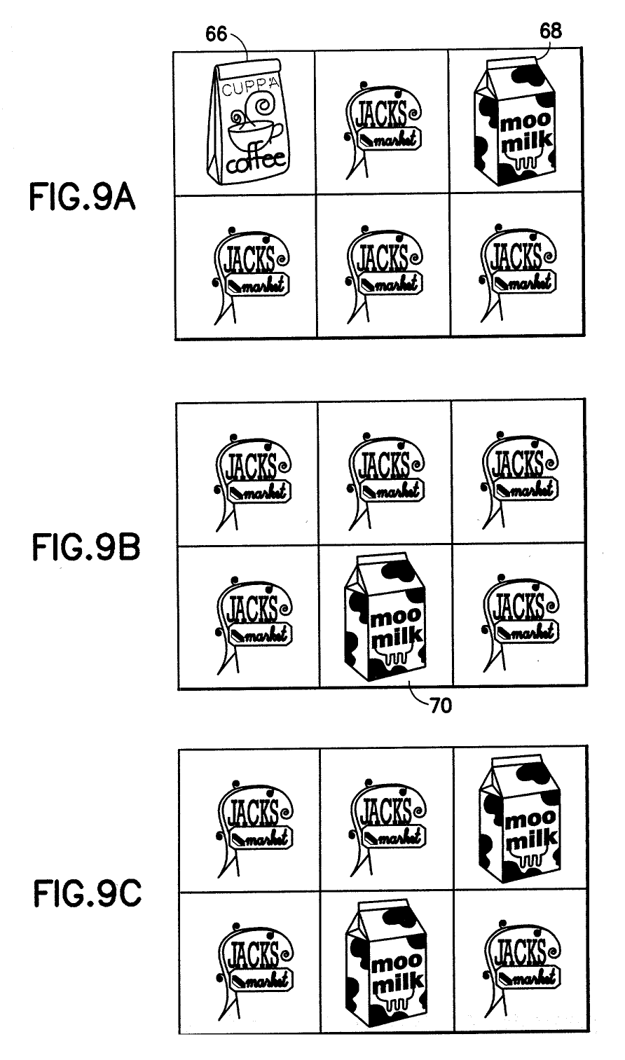

The game begins with the player selecting two cells 66, 68 in sequence to be revealed. FIG. 9A shows such a first turn that results in a non-matching pair of brand images. In many implementations of this game, non-matching pairs are re-hidden prior to the next turn, but this method of play runs counter to the advertising objectives of the game. Consequently, in the preferred embodiment, non-matching brand images remain visible until the player selects the next cell to be revealed and are then re-hidden.

FIG. 9B shows the same game board following the next cell selection 70, i.e., the first half of the second turn. The new cell is revealed, which happens to match one of the images selected in the prior turn but now re-hidden. The player can get a match on this turn by recognizing that this is the same image as was shown in the previous turn, and by remembering which of the two cells selected in the previous turn contains this image. As shown in FIG. 9C, the player in this example is successful in selecting the matching cell. In many conventional implementations of Memory, matching cells disappear from the game board once the match has been revealed, but this method also runs counter to the advertising objectives of this invention. In the preferred embodiment of this invention, cells with matching brand images remain revealed once the match is found. The game is thus complete when all cells are revealed, as shown in FIG. 8A. In a single-player game, a win could be defined as completion of a game within a certain time limit or within a certain number of turns.

In multi-player versions of Memory, the basic playing method of the game is the same as in the single-player embodiment described above, except that players take turns sequentially in revealing hidden cells. Thus each of the players can see all of the revealed images but can attempt to find matches only when it is his or her turn. Moreover, if a player finds a match on a given turn, he or she typically gets another turn immediately. Finally, the winner of a multi-player game is the player who finds the most matches. Multi-player games can be played with all the players in the same room playing on a computer. Alternatively, with the Internet, players can be located anywhere in the world but compete in the same game. In this case, the server apparatus 2 always displays the same game board on each display device 6 participating in the game, but will only accept selection input from one player whose turn it is at any given time.

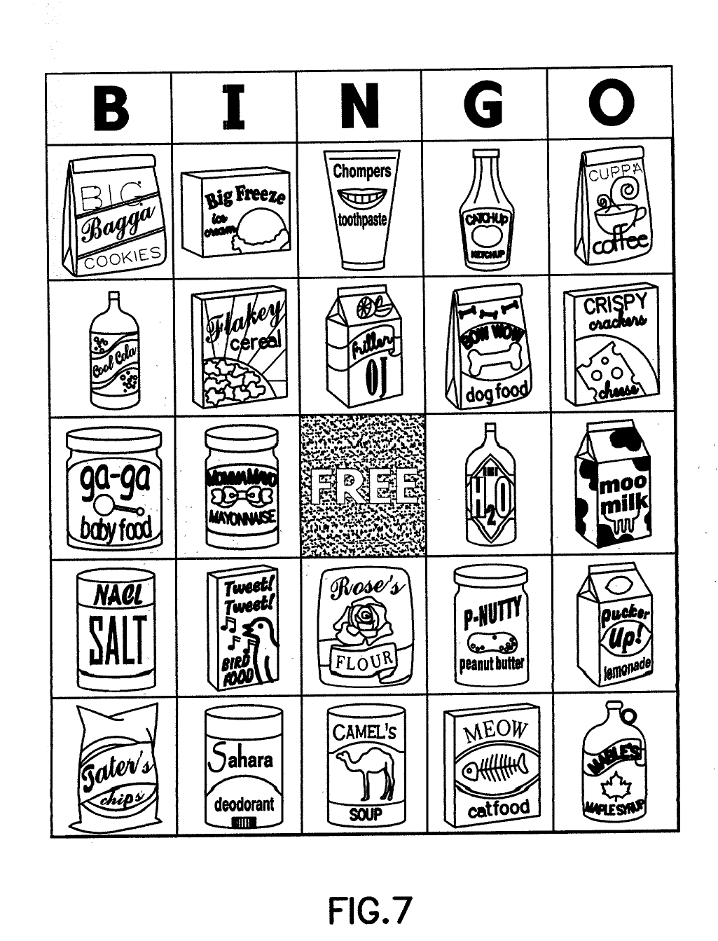

Although illustrative embodiments of the present invention have been described herein with reference to the accompanying drawings, it is understood that the invention is not limited to those precise embodiments and that various changes and modifications may be affected therein by one of ordinary skill in the art. For example, the size of the game board need not include equal numbers of columns and rows. Moreover, the game board can include more or less than five columns and rows so as to correspond to the letters used to designate the columns. The letters at the top of the columns are not limited to the letters “BINGO” and any other word or name can be used (e.g., the name of the store where the game is to be played can be employed). It is also foreseen that the letters can be associated with the rows of the game board instead of the columns and that more than one free space can be provided and that the game board can include no free spaces. It is also foreseen that letters need not be provided to correspond to the rows and/or columns of the game board and only brand images are used (as shown in FIG. 7). While the present invention was explained above in connection with Bingo and Memory games, it is foreseen that the invention is not limited to these types of games but could include other types of games. One alternative example is Keno wherein a user is not required to match the brand image shown on a game board in order, but is only required to match all or a specific number of the brand images displayed on the game board. Another possible example is a slot-machine type of game, wherein a player causes brand images to “spin” (e.g., by flashing) in a plurality of windows on the screen and then stop spinning one by one, and wins when the spinning has stopped and all (or a threshold number) of the windows contain the same brand image.

It is also foreseen that the present invention, as mentioned above, need not be utilized by a shopper in a grocery store, but can be played at a user's home computer, office computer, personal digital assistant (PDA), or via the Internet when the user is not at the store where the products corresponding to the product images can be purchased. It can also be readily understood that the present invention need not be limited to the server-client architecture described herein, but could alternatively be embodied in software that is downloaded onto the user's computer and played in stand-alone mode.

These and other changes of a similar nature are readily apparent to anyone of ordinary skill in the art and, as such, are intended to fall within the scope of the present invention as defined by the following claims.

What is claimed is:

1. A method of playing a product brand image game using a game board including a grid pattern having a plurality of boxes, the method comprising the steps of:
providing a game board to a user, the game board having associated with each of the plurality of boxes at least one of a product image or a “free” space;
selecting a plurality of product images from a database of product images; and
determining which of the plurality of selected product images match the product images present on the game board.

2. The method of playing a product brand image game according to claim 1, wherein when a match is determined between one of the plurality of selected product images and a product image present on the game board, marking the corresponding product image on the game board.

3. The method of playing a product brand image game according to claim 1, wherein each of the plurality of boxes have associated therewith a row and a column, and wherein at least one of the row or column has associated therewith indicia which is common to all of the boxes of the corresponding row or column.

4. The method of playing a product brand image game according to claim 3, wherein each of the selected product images has associated therewith indicia.

5. The method of playing a product brand image game according to claim 4, wherein if the selected product image matches a product image present on the game board, the method further comprises the steps of:
determining at least one of a row and column of the game board in which the matching product image is present and determining the indicia associated with the corresponding row or column;
comparing the indicia associated with the selected product image with the indicia associated with the corresponding row or column of the game board; and
wherein if the indicia of the row or column matches the indicia of the selected product image, concluding that a match has occurred.

6. The method of playing a product brand image game according to claim 5 further comprising the step of:
indicating on the game board that a match has occurred.

7. The method of playing a product brand image game according to claim 1, wherein if it is determined that the selected product image matches at least one of the product images of the game board, indicating on the game board that a match has occurred.

8. The method of playing a product brand image game according to claim 1, wherein the product brand image game is Bingo.

9. The method of playing a product brand image game according to claim 1, wherein the product brand game is Keno.

10. A game board comprising:
a plurality of boxes each having associated therewith a row and a column, each of the plurality of boxes having associated therewith a brand image or a “free” space, each of at least one of the row and column having associated therewith indicia which is deemed to be common to all of the corresponding row or column.

11. A method of encouraging brand image awareness comprising the steps of:
1) configuring a game board for one of Bingo, matching or Keno using brand images; and
2) having a user use the game board to play the corresponding game.

12. A method of playing a product brand image game comprising the steps of:
providing a plurality of boxes having a common picture which is visible to a user, each of the plurality of boxes having associated therewith one of a plurality of brand images, each of the plurality of brand images having at least one matching brand image associated therewith corresponding to a different one of the plurality of boxes, each of the plurality of brand images being non-visible to a user until the corresponding one of the plurality of boxes is selected;
having a user select at least two of the plurality of boxes and revealing the brand images corresponding to the selected boxes to determine if the selected boxes have matching brand images;
wherein if the brand images associated with the selected boxes match, the user is given credit for a match; and
wherein if the brand images associated with the selected boxes do not match, the corresponding non-matching brand images are temporarily revealed to the user and then the non-matching brand images are replaced by the common picture so that they are non-visible to the user.

13. A method of advertising through the use of a product brand image game, comprising the steps of:
presenting to a user a plurality of at least two product images; and
determining which, if any, of the plurality of presented product images are the same.
